(19) United States
(12) Patent Application Publication
(10) Pub. No.: US 2003/0220751 A1
(43) Pub. Date: Nov. 27, 2003

(54) Method and apparatus to verify disc drive vibrational performance

(76) Inventors: Michael Joo Chiang Toh, Singapore (SG); Yong Yang, Singapore (SG); Razman Zambri, Johor Bahru (MY); Xiong Liu, Singapore (SG); Choon Kiat Lim, Singapore (SG)

Correspondence Address: Mitchell K. McCarthy, Seagate Technology LLC, 10321 West Reno, OKM270, Oklahoma City, OK, 73127-7140, US

(21) Appl. No.: 10/440,693

(22) Filed: May 19, 2003

Related U.S. Application Data
(60) Provisional application No. 60/382,791, filed on May 22, 2002.

(51) Int. Cl. G01L 7/00

(52) U.S. Cl. 702/56

(57) ABSTRACT

A method of testing a data storage system such that the data storage system meets vibration performance standards includes the step of adding a reference vibration signal having varying magnitudes into a servo loop of the data storage system to simulate external vibration. The method also includes the step of verifying the external vibration performance by using the simulated external vibration. The simulated external vibration is simulated rotational vibration. Also disclosed is a data storage system configured to implement the method.

### CROSS-REFERENCE TO RELATED APPLICATION

The present application is based on and claims the benefit of U.S. provisional patent application Serial No. 60/382,791, filed May 22, 2002, the content of which is hereby incorporated by reference in its entirety.

### FIELD OF THE INVENTION

The present invention relates generally to methods and components for testing a data storage system to verify specific performance standards. In particular, the present invention relates to verifying vibrational performance in a data storage system by using the data storage system to test itself.

### BACKGROUND OF THE INVENTION

Disc drives are common data storage devices. A typical disc drive includes a rigid housing that encloses a variety of disc drive components. The components include one or more discs having data surfaces that are coated with a medium for storage of digital information in a plurality of circular, concentric data tracks. The discs are mounted on a spindle motor that causes the discs to spin and the data surfaces of the discs to pass under respective hydrodynamic or aerodynamic bearing disc head sliders. The sliders carry transducers, which write information to and read information from the data surfaces of the discs.

In disc drives with relatively high track densities, a servo circuit having a closed-loop is used to maintain a head over the desired track during read or write operations. This is accomplished by using prerecorded servo information either on a dedicated servo disc or on sectors that are interspersed along a disc. During track following operation in which a selected head is maintained over a corresponding track, the servo information sensed by the head is demodulated to generate a position error signal (PES) which provides an indication of the distance between the head and the track center. The PES is then converted into an actuator control signal, which is used to control an actuator that positions the head.

Misalignment of the read/write heads with respect to the tracks causes increases in read/write errors. An external vibration, such as rotational vibration (RV), typically contributes to misalignment of the read/write heads. RV tends to move a disc drive housing about an axis parallel to the axis of disc rotation. Each species of disc drives has a related maximum RV level, which the disc drive can withstand while still meeting standard performance requirements. For example, data throughput or the rate of data transfer is a measure of performance in a disc drive.

A hardware-based test system verifies that a disc drive can meet standard performance requirements during RV. The test system consists of a vibration control system and a drive test system. The drive test system is connected to the drive through a communication interface and collects performance related measurements. The vibration control system utilizes a RV shaker apparatus to induce RV. In addition, the vibration control system controls RV levels during data collection.

This hardware-based test system has many disadvantages. First, a significant amount of time is needed to collect performance measurements and for the vibration control system to ramp from zero vibration to the specified vibration level. Second, the testing system is not automated. Therefore, workers are needed to perform and complete each test. Next, the existing vibration control system poses a testing limitation during low level vibration. The vibration controller includes an accelerometer feedback to control and regulate the vibration levels. At low vibrations, the feedback is mixed with electrical noise causing poor signal to noise ratio. The poor signal to noise ratio will produce an inaccurate measurement or shutdown the system entirely. Lastly, the vibration control system is very costly. The test system consists of expensive capital investments such as a shaker, amplifier, control computer, charge amplifier and an accelerometer. The method of performing RV testing which addresses one or more of these problems or other problems associated with RV testing, would be a significant improvement in the art.

### SUMMARY OF THE INVENTION

A method of testing a data storage system such that the data storage system meets vibration performance standards includes the step of adding a reference vibration signal having varying magnitudes into a servo loop of the data storage system to simulate external vibration. The method also includes the step of verifying the external vibration performance by using the simulated external vibration. In a specific embodiment, the simulated external vibration is rotational vibration. Also disclosed is a data storage system configured to implement the method.

Other features and benefits that characterize embodiments of the present invention will be apparent upon reading the following detailed description and review of the associated drawings.

### BRIEF DESCRIPTION OF THE DRAWINGS

FIG. 1 is a perspective view of a disc drive.

FIG. 2 is a perspective view of a disc drive illustrating the general direction of rotational vibration.

FIG. 3 is a top view of a section of disc illustrating an ideal track and a realized track with position error.

FIG. 4 is a flow chart of a method of verifying vibrational performance in a disc drive such that the disc drive meets specific performance standards in accordance with an embodiment of the present invention.

FIG. 5 is a block diagram of a vibrational testing system in accordance with the present invention.

FIG. 6 is a block diagram of a servo system in accordance with an embodiment of the present invention.

FIG. 7 is a flow chart of a method for carrying out the verification of rotational vibration by a disc drive itself in accordance with an embodiment of the present invention.

FIG. 8 is a flow chart of a specific method of FIG. 7 in accordance with an embodiment of the present invention.

FIG. 9 is a flow chart of a method of determining the correlation coefficient as introduced in FIG. 7 and FIG. 8 in accordance with an embodiment of the present invention.

FIG. 10 is a plot of rotational vibration (RV) versus non-repeatable run-out (NRRO) as derived in FIG. 9.

FIG. 11 is a plot of the scale of the reference vibration signal versus NRRO as derived in FIG. 9.

### DETAILED DESCRIPTION OF ILLUSTRATIVE EMBODIMENTS

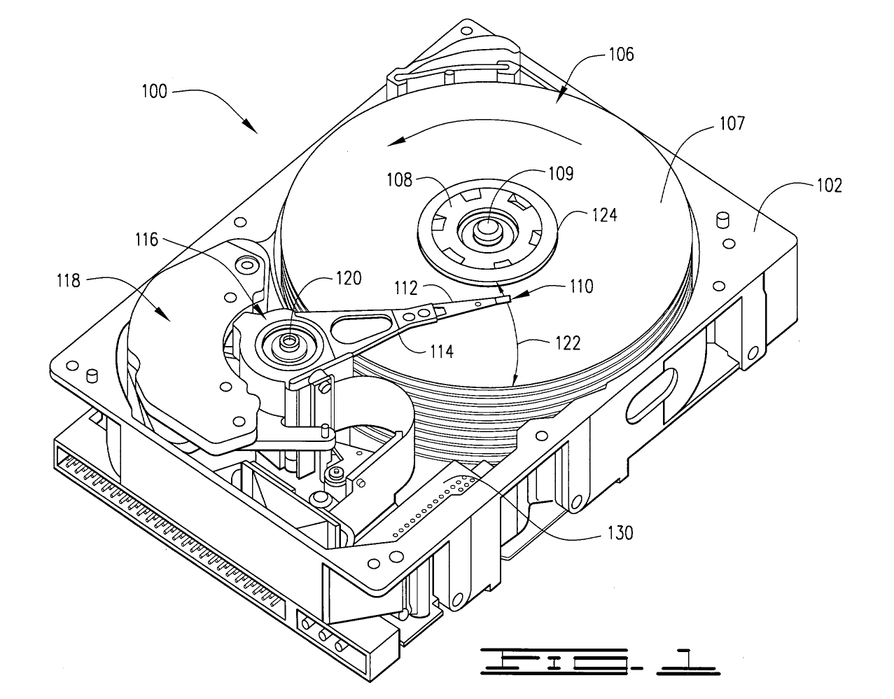

FIG. 1 is a perspective view of disc drive 100 that includes a housing with a base deck 102 and top cover (not shown). Disc drives are common data storage systems. Disc drive 100 further includes a disc pack 106, which is mounted on a spindle motor (not shown) by a disc clamp 108. Disc pack 106 can include one or more discs and is illustrated with a plurality of individual discs 107, which are mounted for co-rotation about axis 109 in a direction indicated by arrow 132. Each disc surface has an associated slider 110 which carries a read/write head for communication with the disc surface. In the example in FIG. 1, sliders 110 are supported by suspension 112 which is in turn attached to track accessing arm 114 of an actuator assembly 116. Actuator assembly 116 is of the type known as a rotary moving coil actuator and includes a voice coil motor (VCM), shown generally at 118. VCM 118 rotates actuator 116 about pivot shaft 120 to position sliders 110 over a desired data track along an arcuate path 122 between a disc inner diameter 124 and a disc outer diameter 126. VCM 118 is driven by electronic circuitry 130 based on signals generated by the read/write heads and a host computer (not shown). Electronic circuitry 130 includes a closed-loop circuit for controlling the head position of the actuator assembly 116.

Any given disc drive, such as disc drive 100, is associated with various performance specifications. For example, data throughput is a measure of performance in disc drive 100. Data throughput is the rate at which data is transferred to the host computer. At least a minimum level of data throughput must be maintained even in the presence of externally applied vibrations that can seriously impede the ability of electronic circuitry 130 to sustain slider 110 on any given track.

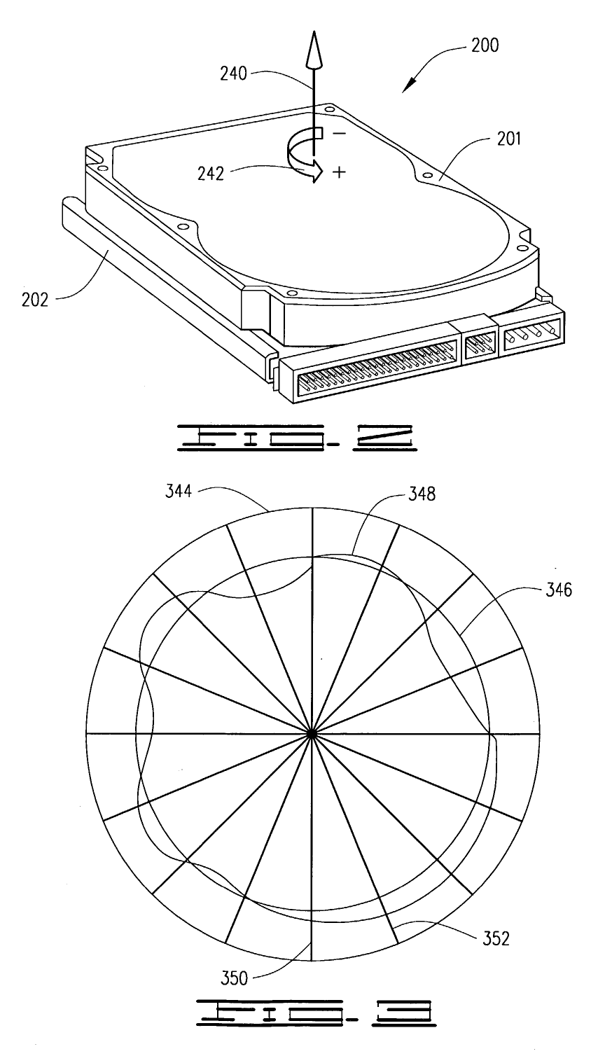

Rotational vibration (RV) is a specific type of externally applied vibration and is particularly detrimental to the performance of disc drive 100. FIG. 2 is a perspective view of disc drive 200 having a base deck 202 and top cover 201. For example, disc drive 200 can be the disc drive 100 of FIG. 1, and should be considered to contain similar components to those described above. RV tends to rotate disc drive 200 about an axis 240 in direction 242. Referring back to FIG. 1, disc 107 is rigidly mounted to the spindle motor, which is rigidly mounted to base deck 102. Under RV, the disc 107 will move in relation to the amplitude and phase of the applied RV. The actuator assembly 116 is a free body and will tend to remain in place. Therefore, disc 107 will move back and forth under sliders 110 causing error in head position.

FIG. 3 is a top view of a section 344 of a disc showing an ideal, perfectly circular track 346 and an actual track 348. Section 344, for example, can be a section of disc 107 in FIG. 1. Section 344 includes a plurality of radially extending servo fields such as servo fields 350 and 352. The servo fields include servo information that identifies the location of actual track 348 along disc section 344.

Any variation in the position of a head away from circular track 346 is considered a position error. There are two types of position errors. There is written-in repeatable run-out (RRO) position errors and non-repeatable run-out (NRRO) position errors. A position error is considered a RRO error if the error arises during the creation and writing of the servo fields. These written-in errors or RRO errors occur because the write head used to produce the servo fields does not always follow a perfectly circular path. Unpredictable pressure effects on the write head from the aerodynamics of its flight over the disc and vibrations in the slider used to support the head are common problems during servo information writing. Because of these written-in errors, a head that perfectly tracks the path followed by the servo write head will not follow a perfectly circular path. Track 348 has a written-in error because each time a head follows the servo fields that define track 348, it produces the same position error relative to ideal track 346.

A position error is considered a NRRO error if the error arises during the presence of externally applied vibrations. In addition to track 348 having a written-in error, track 348 also includes any NRRO position error. For example, rotational vibration (RV) is a NRRO position error.

After manufacture, disc drives, such as disc drives 100 and 200, must be tested to determine whether or not the systems can meet performance standards for that particular system at a maximum rotational vibration (RV) level. Generally, testing disc drives to verify RV performance requires a drive test system and a vibrational control system. The drive test system is connected to the drive through a communication interface and collects performance related measurements, such as data throughput and position error signal (PES). A software program, such as MATLAB created and sold by The Mathworks, Inc. of Natick, Mass., is used to analyze and collect the data. The vibrational control system includes a RV shaker apparatus to induce RV. The vibrational control system controls RV levels during data collection.

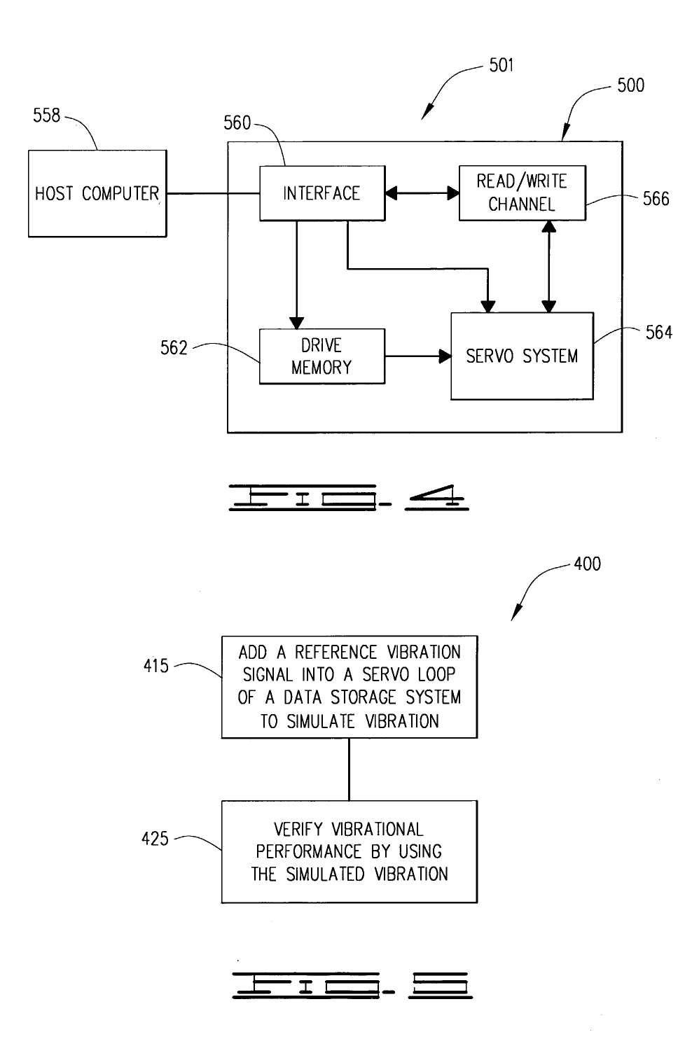

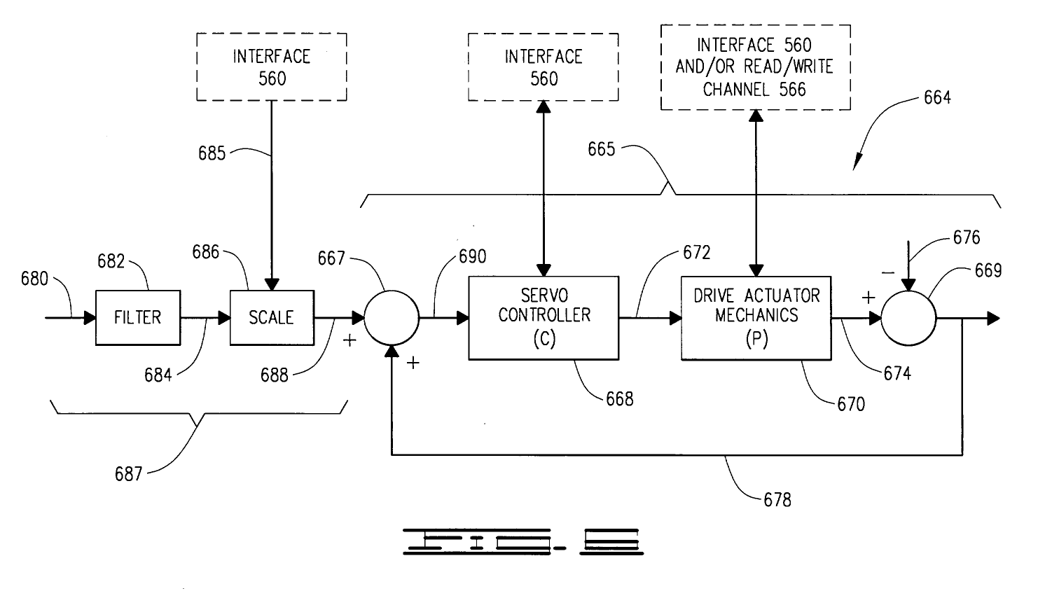

The above method of testing disc drives to verify RV performance is time consuming, labor intensive, limiting and costly. To eliminate these unwanted testing conditions, the present invention is a testing system which verifies vibrational performance by the disc drive itself. FIG. 4 is a flow chart 400 of a method for verifying vibrational performance in a disc drive in accordance with the present invention. In step 415, a reference vibration signal is added into a servo loop of a disc drive which is acting under a servo test code (see FIG. 5 description) to simulate external vibration. In step 425, the disc drive verifies vibrational performance by using the simulated vibration. For example, the method for verifying vibrational performance can be a method for verifying rotational vibration. Both steps 415 and 425 of FIG. 4 will be thoroughly described below.

FIG. 5 is a very simplified block diagram of a vibrational testing system 501 in accordance with an embodiment of the present invention. Vibrational testing system 501 includes host computer 558 coupled to disc drive 500 by an interface lo 560. Disc drive 500 can be an embodiment of disc drives 100 and 200 described above. Interface 560, for example, can be a communication port. Host computer 558 stores different types of servo codes in its memory, such as a servo test code and a servo operational code. A servo test code contains code and instructions for operating servo system 564 in disc drive 500 during a testing mode. A servo operational code contains code and instructions for operating servo system 564 under normal operational use. To verify rotational vibration (RV) performance standards in disc drive 500, host computer 558 downloads the servo test code into drive memory 562 of disc drive 500. The existing servo code in drive memory 562 is over-written by the downloaded servo test code from host computer 558. Typically, at any given time, only one type of servo code exists in drive memory 562.

Host computer 558 also issues commands to servo system 564. For example, the host computer 558 can communicate to servo system 564 what track to seek during track seeking operation. During track following operation, host computer 558 collects performance data from disc drive 500 in addition to data read from the disc. For example, when servo system 564 is using servo test code, host computer 558 can collect non-repeatable run-out (NRRO) error and bit error rate. The data read from the disc and other performance data collected flows through read/write channel 566 and is collected by host computer 558 via interface 560. Host computer 558 determines how fast the data is being transferred from servo system 564. This rate of data transfer is data throughput.

FIG. 6 is a block diagram of an expanded view of a portion of servo system 664 in accordance with an embodiment of the present invention. Servo system 664 can be servo system 564 of FIG. 5 operating under the servo test code. Servo system 664 includes a closed-loop circuit which includes a servo controller 668 having a gain of “C” and drive actuator mechanics 670 having a gain of “P.” Thus, servo system 664 can be considered to be, or to include, a servo loop 665. Servo loop 665 includes, for example, servo controller 668, drive actuator mechanics 670, addition circuitry 667 and subtraction circuitry 669. Servo system 664 can include the servo control circuitry within electronic circuitry 130 of FIG. 1. Drive actuator mechanics 670 of servo loop 665 includes, for example, actuator assembly 116, voice coil motor 118, track accessing arm 114, suspension 112 and sliders 110 having associated read/write heads or transducers, all of FIG. 1. As shown in FIG. 6, various components of servo system 664 are coupled to interface 560 and/or read/write channel 566 (both originally shown in FIG. 5). Thus, servo system 664 can receive instructions from a controller, such as host computer 558. Also, the read/write heads of drive actuator mechanics 670 are coupled to the read/write channel 566 so that data throughput can be monitored by a controller, again such as host computer 558.

Servo controller 668 generates a control current 672 that drives the voice coil motor of disc actuator mechanics 670. In response, drive actuator mechanics 670 produces a head motion represented by signal 674. A separate input signal 676 represents written-in error (RRO). Even though the written-in error would otherwise appear implicitly in signal 674, the separation of written-in error 676 from head motion signal 674 provides a better understanding of the present invention. The difference between head motion signal 674 and written-in error 676 results in position error signal (PES) 678 at the output of subtraction circuitry 669.

Random noise signal 680 is injected into servo loop 665. Random noise signal 680 will simulate rotational vibration (RV). However, random noise signal 680 must first be conditioned. First, signal 680 passes through low pass filter circuitry 682. Low pass filter circuitry 682 filters out frequencies which are out of the rotational vibration range. Each type of disc drive has different frequency ranges to simulate RV. For example, Seagate Technology of Scotts Valley, Calif. has a specification frequency range of 10 to 300 Hz. for rotational vibration on their model C1 disc drive. Therefore, in this non-limiting example, filter circuitry 682 can be configured to remove frequencies above 300 Hz.

The resulting filtered random noise signal is initial reference vibration signal 684. Signal 684 is integrally scaled at scale circuitry 686. Filter circuitry 682 and scale circuitry 686 can be, for example, implemented in software when servo test code is downloaded into the servo system. Thus, when operational code is downloaded, filter circuitry 682 and scale circuitry 686 can be eliminated. Scale circuitry 686 varies the magnitude of initial reference vibration signal 684 with commands issued by the host computer, such as host computer 558 of FIG. 5. The command issued by the host computer is represented by signal 685. The host computer can increase and decrease the magnitude of initial reference vibration signal 684 with scale circuitry 686. Therefore, reference vibration signal 688, as described in step 415 of FIG. 4, represents initial reference vibration signal 684 with a given magnitude. Reference vibration signal 688 is added to the servo loop 665 to simulate rotational vibration (RV). Signal 688 can also be designated as NRRO error injected into servo loop 665 in the form of (RV). For reference purposes, in one embodiment, circuitry 682 and 686 forms reference vibration signal (or NRRO error signal) generating circuitry 687. The NRRO that is generated due to the initial reference vibration signal 684 and scale 586 is represented by:

$$NRRO = \frac{CP}{1 + CP} \times \begin{matrix}reference \\ vibration \\ signal\end{matrix} \times scale$$

where C is the gain due to servo controller 668 and P is the gain due to drive actuator mechanics 670.

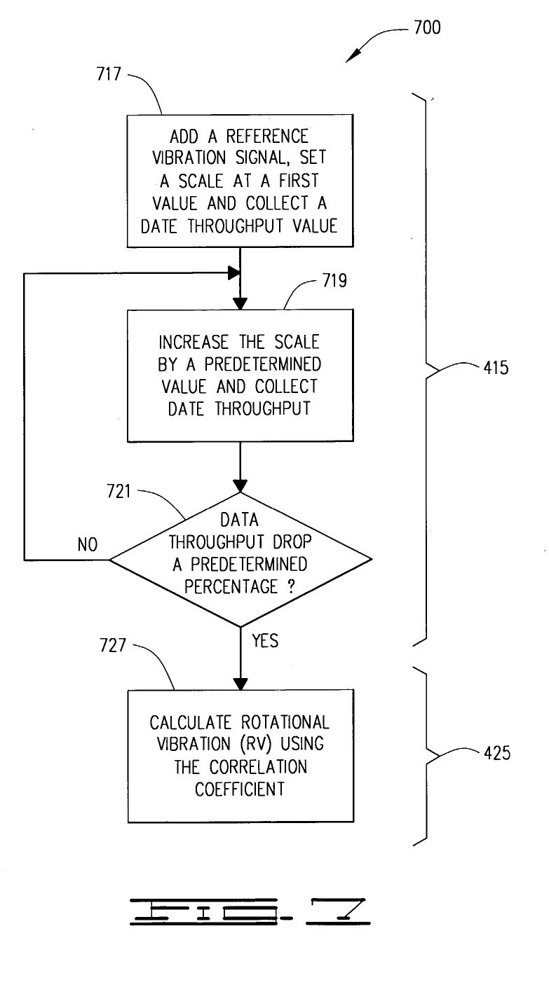

In one aspect of the present invention, flow chart 400 of FIG. 4 can be flow chart 700 shown in FIG. 7. Flow chart 700 represents a method of carrying out the verification of rotational vibration (RV) by the disc drive itself. For example, steps 717, 719 and 721 are sub-steps of step 415 in FIG. 4, and step 727 is a more descriptive step of step 425 in FIG. 4. In step 717, a reference vibration signal, such as initial reference vibration signal 684 of FIG. 6 is added into a servo loop, such as servo loop 665 of FIG. 6. A scale, such as a scale produced by scale circuitry 686 of FIG. 6, is set to a first value by a host computer, such as host computer 558 of FIG. 5. The host computer then collects a first data throughput value of the disc drive while operating under this particular reference vibration signal and scale. In step 719, the host computer instructs the scale circuitry to increase the scale by a predetermined value. Again, the host computer collects data throughput at the increased scale.

In step 721, the host computer divides the data throughput value collected in step 719 by the first data throughput value collected in step 717 to determine a percentage. This determined percentage represents the drop in data throughput incurred from the first data throughput value collected in step 717 to the data throughput value collected in step 719. Stated another way, this determined percentage represents the percentage of the original data throughput value collected in step 717 that the data throughput value collected in step 721 has dropped to. In step 721, the determined percentage is also compared to a predetermined percentage. The predetermined percentage is a minimum percentage value that the determined percentage can drop to in step 721 such that a disc drive can continue to correctly operate. If the determined percentage in step 721 is greater than the predetermined percentage, then the method repeats steps 719 and 721 until the determined percentage is less than or equal to the predetermined percentage. If the determined percentage in step 721 is less than or equal to the predetermined percentage then the flow chart moves on to step 727. In step 727, RV is calculated using a correlation coefficient between RV and the scale. To calculate rotational vibration (RV), the correlation coefficient must first be determined. The determination of the correlation coefficient is thoroughly discussed in the description of FIG. 9 below.

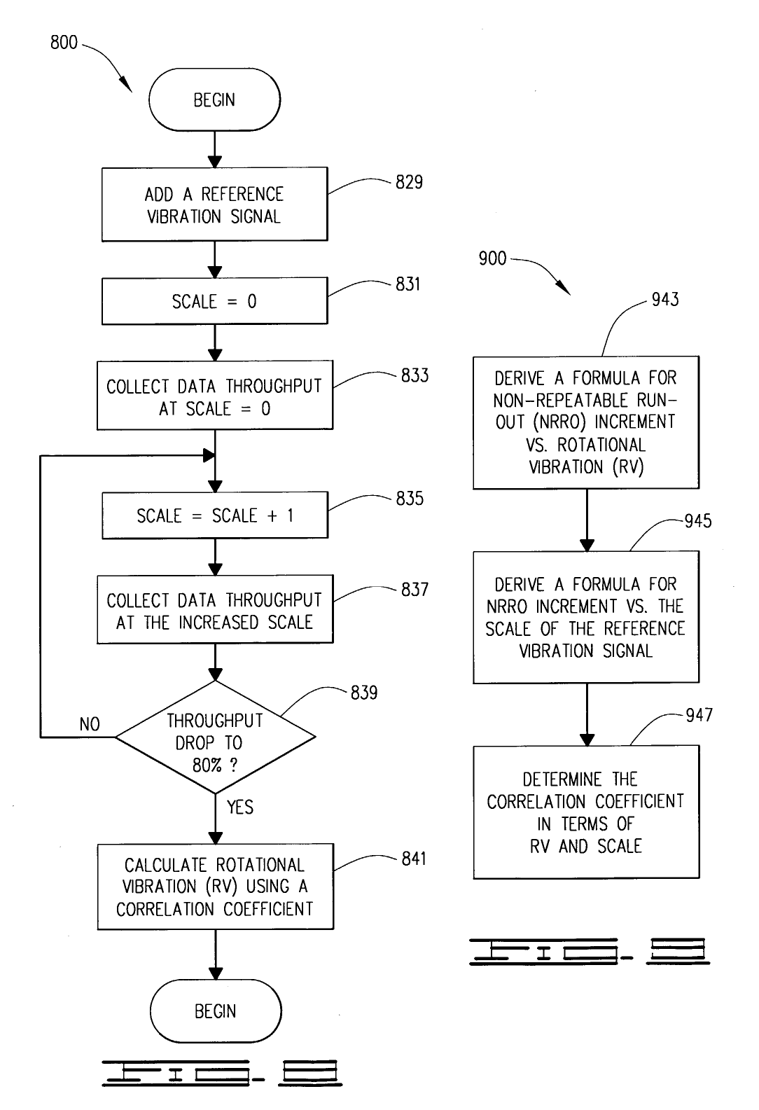

In another aspect of the present invention, FIG. 8 is flow chart 800 of a method of carrying out the verification of rotational vibration (RV) by the disc drive itself. In step 829, a reference vibration signal, such as initial reference vibration signal 684 of FIG. 6, is added into a servo loop, such as servo loop 665 of FIG. 6. In step 831, a scale, such as a scale produced by scale circuitry 686 of FIG. 6, is set to zero by a host computer, such as host computer 558 of FIG. 5. In step 833, the host computer collects a first data throughput value at a scale equal to zero. In step 835, the scale is set to scale plus one (or scale plus other predetermined increments). For example, if the scale is equal to zero as in step 831, then the new increased scale is equal to one because the scale increased by an integer of one. In step 837, the host computer collects data throughput at scale equal to scale plus one.

At step 839, the host computer divides the first data throughput value collected in step 833 by the data throughput value collected in step 837 to determine a percentage. This determined percentage represents the drop in data throughput incurred from the first data throughput value collected in step 833 to the data throughput value collected in step 837. In step 839, the determined percentage is also compared to 80% or to other percentage values in other embodiments. This percentage (80% or other percentage values in other embodiments) is a minimum percentage value that the determined percentage can drop to in step 839 based on performance standards set out for different types of disc drives. If the determined percentage in step 839 is greater than 80%, in this example, then the method repeats steps 835, 837 and 839.

At repeated step 835, the scale increases to scale plus one (or scale plus other predetermined increments). For example, if the scale was equal to one then the new increased scale is equal to two. At repeated step 837, data throughput is collected at a scale equal to scale plus one. At repeated step 839, the host computer divides the first data throughput value collected in step 833 by the data throughput value collected in repeated step 837 to determine a new percentage. This new determined percentage represents the drop in data throughput incurred from the first data throughput value collected in step 833 to the data throughput value collected in repeated step 837. If the new determined percentage in repeated step 839 is still greater than 80% then the method repeats steps 835, 837 and 839 again. If, however, the new determined percentage is less than or equal to 80%, then flow chart 800 continues to step 841. In step 841, RV is calculated using a correlation coefficient between RV and the scale. As discussed above, to calculate RV, the correlation coefficient must first be determined. The determination of the correlation coefficient is thoroughly discussed in the description of FIG. 9 found below.

To verify vibrational performance of a disc drive with the disc drive itself as described in the methods of FIG. 4, FIG. 7 and FIG. 8, a correlation coefficient relating rotational vibration (RV) to the scale is needed. The correlation coefficient is related to gain “C” of servo controller 668 and to gain “P” of drive actuator mechanics 670, both of FIG. 6. Therefore, a correlation coefficient can be determined in one disc drive and can be applied to all other disc drives with a similar gain “C” and gain “P.”

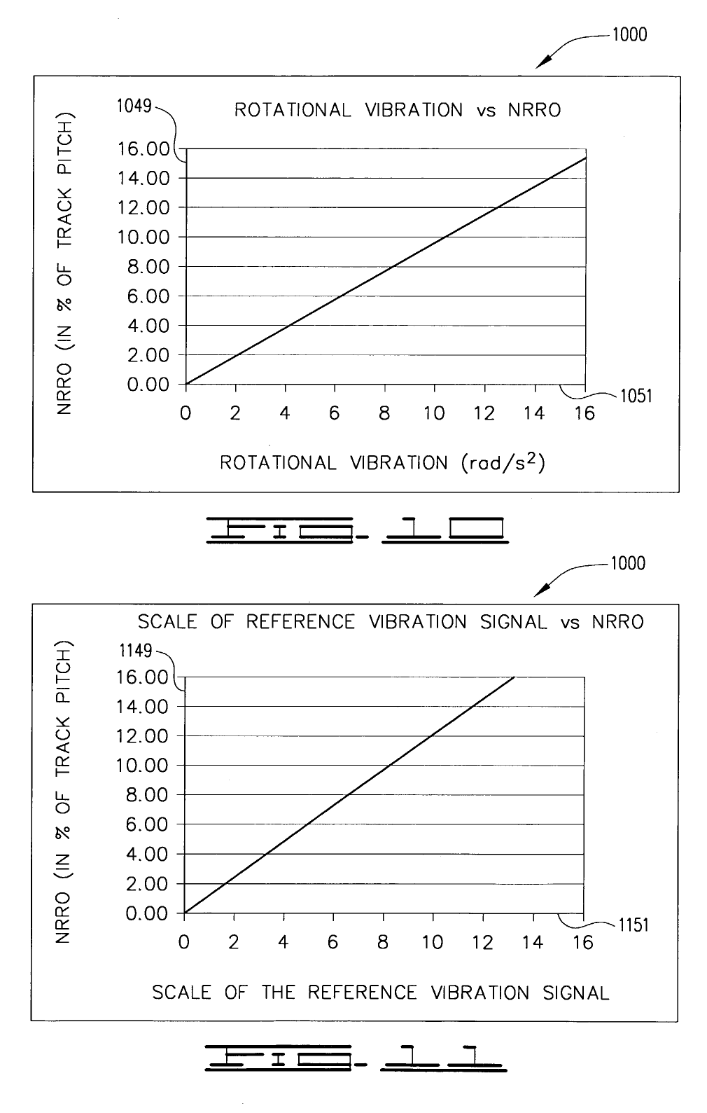

FIG. 9 is a flow chart 900 of a method of determining the correlation coefficient as introduced in FIG. 7 and FIG. 8. To determine a correlation coefficient, a formula for non-repeatable run out (NRRO) increment verses rotational vibration (RV) is derived in step 943. To derive the formula in step 943 in one embodiment, an RV shaker is installed on the disc drive in order to induce rotational vibration. The RV shaker induces and varies RV levels in a disc drive. First, a host computer will collect the measurement of an NRRO baseline. An NRRO baseline is the NRRO of the disc drive with no induced RV by the RV shaker. After this value is collected, the RV shaker increases the RV level. The host computer then collects an NRRO at this increased RV level. An NRRO increment is then calculated by subtracting the NRRO baseline from the NRRO collected at an increased RV level. Increasing the RV level, collecting NRRO and calculating the NRRO increment is repeated until the NRRO increment exceeds 15% (or other predetermined percentages) of track pitch. Track pitch is generally referred to as the distance between the centers of a track and its adjacent track. Therefore, if the NRRO increment at a given RV level produces a position error that is equal to more than 15% (or other predetermined percentages) of the distance between centers of tracks, then collecting NRRO is discontinued. All data collected is plotted on a NRRO increment verses rotational vibration graph. For example, FIG. 10 is an example plot of NRRO increment verses rotational vibration. In FIG. 10, axis 1049 is an NRRO increment in terms of the percent of track pitch. Axis 1051 is rotational vibration in radians per second squared. By using the least squares method, a best fit line can be drawn through these set of data points. The equation of the line is represented by:

Y=MX+B Equation 2

where Y is the NRRO increment, X is rotational vibration, M is the slope of the line and B is the Y-intercept. Since NRRO increment is zero at a rotational vibration equal to zero, the Y-intercept equals zero. In the example plot 1000, a line is best fit to the example data points and results in a slope (M) of 0.92. Values are substituted into Equation 2 and the resulting equation is represented by:

Y=0.92×X1 Equation 3

where Y is the value of NRRO due to the RV shaker in terms of percentage of track pitch and X1 is the rotational vibration of the RV shaker.

Next, flow chart 900 continues on to step 945. In step 945, the formula for NRRO increment verses the scale of the reference vibration signal is derived. To derive a formula for NRRO increment verses the scale of the reference vibration signal, a reference vibration signal is added to a servo loop, such as the portion of servo system 664 of FIG. 6. A scale, such as a scale produced by scale circuitry 686 of FIG. 6, is set at zero. A host computer, such as host computer 558 of FIG. 5, then collects NRRO. This NRRO is called NRRO baseline. The scale is then increased by scale equal to scale plus one. Again, the host computer collects NRRO at this increased scale. The NRRO increment is then calculated by subtracting the NRRO baseline from the NRRO collected at an increase scale. Increasing the scale, collecting NRRO and calculating an NRRO increment is repeated until the NRRO increment exceeds 15% (or other predetermined percentages) of track pitch. All data collected from the NRRO increment verses the scale is plotted on a graph. For example, FIG. 11 is an example plot of NRRO increment versus scale. In FIG. 11, axis 1149 is an NRRO increment in terms of the percent of track pitch. Axis 1151 is the scale of the reference vibration signal. By using the least squares method, a best fit line can be drawn through these set of data points. Since NRRO increment is zero at a rotational vibration equal to zero, the Y-intercept equals zero. In the example plot 1100, a line is best fit to the example data points and results in a slope (M) of 1.38. Values are substituted into Equation 2 and the resulting equation is represented by:

Y=1.38×X2 Equation 4

where Y is the value of NRRO due to the reference vibration signal in terms of percentage of track pitch and X2 is the scale of the reference vibration signal.

Flow chart 900 then continues to step 947. In step 947, a correlation coefficient is determined in terms of RV and scale. By substituting Y in equation 3 with Y in equation 4, the resulting equation is represented by:

X1=1.51×X2 Equation 5

where X1 is rotational vibration (RV) and X2 is the scale. This equation represents the correlation between RV and the scale. The correlation coefficient derived from example plots 1000 and 1100 is 1.51, which is the ratio of the slopes in Equations 3 and 4.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular steps and elements may vary depending on the particular application for the disc drive, while maintaining substantially the same functionality without departing from the scope and spirit of the present invention.

What is claimed is:

1. A method of testing a data storage system such that the data storage system meets vibration performance standards, the method comprising:
adding a reference vibration signal having varying magnitudes into a servo loop of the data storage system to simulate external vibration; and
verifying the external vibration performance by using the simulated external vibration.

2. The method of claim 1, wherein adding the reference vibration signal to simulate external vibration further comprises adding the reference vibration signal to simulate rotational vibration (RV) and wherein verifying the external vibration performance further comprises verifying RV performance by using the simulated RV.

3. The method of claim 2, wherein the step of adding the reference vibration signal further comprises:
(a) setting a scale to a first value and collecting a first data throughput value, the scale varying the magnitude of the reference vibration signal;
(b) increasing the scale by a predetermined value and collecting a data throughput value at the increased scale;
(c) dividing the data throughput value at the increased scale by the first data throughput value to determine a percentage; and
(d) comparing the determined percentage to a predetermined percentage.

4. The method of claim 3 wherein when the determined percentage is greater than the predetermined percentage, the method further comprising repeating steps (b), (c) and (d) until the determined percentage is less than the predetermined percentage.

5. The method of claim 3 wherein when the determined percentage is less than the predetermined percentage, a RV value is calculated in terms of a correlation coefficient and the scale.

6. The method of claim 3, wherein when the determined percentage is equal to the predetermined percentage, a RV value is calculated in terms of a correlation coefficient and the scale.

7. The method of claim 2 wherein the step of verifying RV performance further comprises:
providing a scale, wherein varying a value of the scale varies the magnitude of the reference vibration signal;
determining a correlation coefficient; and
calculating RV with in terms of correlation coefficient and the scale.

8. The method of claim 7 wherein determining the correlation coefficient comprises:
deriving a formula for a non-repeatable run-out (NRRO) increment related to RV;
deriving a formula for the NRRO increment related to the scale of the reference vibration signal; and
determining the correlation coefficient in terms of RV and the scale.

9. The method of claim 8, wherein deriving the NRRO increment related to RV further comprises:
(a) installing a RV shaker to induce and vary RV levels in the data storage system;
(b) measuring a NRRO baseline, wherein the NRRO baseline is the NRRO of the data storage system with no induced RV by the RV shaker;
(c) increasing the RV level to an increased RV level and collecting NRRO at the increased RV level;
(d) calculating the NRRO increment by subtracting the NRRO baseline from the NRRO collected at the increased RV level;
(e) repeating steps (c) and (d) until the NRRO increment exceeds a predetermined percentage of track pitch; and
(f) plotting NRRO increment calculated in step (e) versus RV.

10. The method of claim 8, wherein deriving the NRRO increment related to the scale further comprises:
(a) adding the reference vibration signal to the servo loop;
(b) setting the scale to zero;
(c) collecting a NRRO baseline value;
(d) increasing the scale by a predetermined value and collecting a NRRO value at the increased scale;
(e) calculating the NRRO increment by subtracting the NRRO baseline value from the NRRO value collected at the increased scale;
(f) repeating steps (d) and (e) until the NRRO increment exceeds a predetermined percentage of track pitch; and
(g) plotting the NRRO increment calculated from step (e) versus the scale.

11. A data storage system configured to verify vibrational performance, the data storage system having a servo system, the servo system comprising:
reference vibration signal generating circuitry which generates a reference vibration signal;
a servo loop coupled to the reference vibration signal generating circuitry, the servo loop configured to generate a control signal, as a function of the reference vibration signal, to drive a voice coil motor of the data storage system, and to thereby test the vibrational performance of the data storage system.

12. The data storage system of claim 11, wherein the servo loop is configured to generate a position error signal, and to combine the reference vibration signal and the position error signal to generate the control signal.

13. The data storage system of claim 12, wherein the voice coil motor is part of drive actuator mechanics, the drive actuator mechanics comprising part of the servo loop and further including read/write heads which read data and servo information from a storage medium of the data storage system.

14. The data storage system of claim 13, wherein the drive actuator mechanics are configured to generate a head position signal, and wherein the position error signal is calculated by subtracting the head position signal from a written-in error.

15. The data storage system of claim 13, wherein the servo loop further comprises a servo controller which receives the combined position error signal and reference vibration signal as an input, and which generates the control signal in response.

16. A vibrational testing system including the data storage system of claim 13, the vibrational testing system further comprising a host computing device coupled to the drive actuator mechanics through a read/write channel of the data storage system, the host computing device receiving data from the read/write channel, which was read from the storage medium while the reference vibration signal was provided to the servo loop, in order to monitor data throughput to verify vibrational performance of the data storage system.

17. The data storage system of claim 11, wherein the reference vibration signal simulates a rotational vibration of the data storage system.

18. A data storage system configured to verify vibrational performance, the data storage system having a servo system, the servo system comprising:
means for generating a reference vibration signal; and
a servo loop coupled to the means for generating the reference vibration signal, the servo loop configured to generate a control signal, as a function of the reference vibration signal, to drive a voice coil motor of the data storage system, and to thereby test the vibrational performance of the data storage system.

19. The data storage system of claim 18, wherein the means for generating the reference vibration signal further comprises:
filter circuitry which receives a random noise signal as an input, and generates an initial reference vibration signal as an output; and
scale circuitry coupled to the filter and configured to multiply the initial reference vibration signal by a scaling factor to generate the reference vibration signal.

20. The data storage system of claim 18, wherein the reference vibration signal simulates a rotational vibration of the data storage system.
